(19) United States
(12) Patent Application Publication
(10) Pub. No.: US 2002/0178145 A1
(43) Pub. Date: Nov. 28, 2002

(54) Information distribution method, information distribution system and information distribution apparatus

(76) Inventor: Takehisa Ishida, Tokyo (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/126,870

(22) Filed: Apr. 19, 2002

(30) Foreign Application Priority Data
Apr. 26, 2001 (JP) P2001-128686

(51) Int. Cl. G06F 7/00

(52) U.S. Cl. 707/1

(57) ABSTRACT

The present invention introduces an information distribution method capable of making an information distribution business for reliably authenticating a recording medium and distributing information in a prepaid manner. For this end, ID information recorded in a read-only area is read out from a disc-shaped recording medium having a read-only area and a recording and/or reading area. Judgment (or decision) is made whether or not information distribution to the recording medium is permitted based on the read-out ID information. The signal information distributed as a result of the judgment is recorded in the recording and/or reading area of the recording medium. The recording and/or reading area of the recording medium is rewritable. In case of reading the ID information out of the read-only area of the recording medium, erasing of recorded information for the recording and/or reading area is performed at the recording position for the ID information before reading the ID information.

### CROSS REFERENCE TO RELATED APPLICATIONS

This application claims priority to Japanese Patent Application No. JP 2001-128686, filed on Apr. 26, 2001, the disclosure of such application being herein incorporated by reference to the extent permitted by law.

### BACKGROUND OF THE INVENTION

1. Field of the Invention

The present invention relates to an information distribution method for distributing information as signal information such as, e.g., data, software, video or audio, an information distribution system for implementing such method and an information distribution apparatus for such system. More specifically, the present invention relates to an information distribution method, an information distribution system and an information distribution apparatus for reliably distributing signal information only to specific recording media.

2. Related Art

Popularization of networks and in particular the Internet in recent years have given birth to a new business of distributing information such as software, music and video in the form of electrical signal over a network, instead of conventional package media such as compact discs or video cassettes. Distribution of such information is typically performed by transmitting the information after authentication of the sender by user name and password or by transmitting the information in exchange for a credit card number, for example.

Providing security for protecting distributed information from unauthorized access and for performing adequate charging is very important for information distribution on a network. However, such conventional authentication by user name and password may fail to exclude a third party passing oneself as an authorized receiver, thereby exposing the information distributor to unauthorized use of information. Also, the receiver of the distributed information may have the risk of being overcharged for a distribution that he/she has not authorized. There is a similar risk when sending/transmitting/receiving a credit card number.

### SUMMARY OF THE INVENTION

It is desirable according to the present invention to provide an information distribution method, an information distribution system and an information distribution apparatus capable of reliably distributing signal information only to specified recording media, thereby capable of safely and reliably collecting charges for the distributed information.

It is provided, according to a preferred embodiment of the present invention, an information distribution method including: reading ID information recorded in a read-only area of a recording medium having the read-only area and a recording and/or reading area; deciding whether information distribution is permitted or refused based on the read-out ID information; and recording distributed information as a result of the deciding step on the recording and/or reading area.

In such information distribution method, a recording medium is authenticated based on the non-rewritable ID information recorded in the read-only area of the recording medium. As a result, judgment (or decision) on information distribution is made based on authentication of the recording medium and distributed information is recorded in the authenticated recording medium.

Preferably, when reading the ID information from the read-only area of the recording medium, the reading process of said ID information is performed after an erasing process performed at a recording position of said ID information corresponding to information recorded on said recording and/or reading area.

When the ID information is read in the above manner, no signal can be read out if the recording and/or reading area of the recording medium is information of rewritable type and if the ID information is read in an area other than the read-only area. In other words, only the information (i.e., ID information) in the read-only area can be read. As a result, the recording medium is reliably authenticated based only on the ID information initially recorded in the read-only area of the recording medium, thereby ensuring distribution of information exclusively to the authenticated recording medium.

Another preferred embodiment of the present invention presents an information distribution system having a recording and/or reading apparatus for recording and reading information in a recording medium, and an information distribution apparatus including a first database comprising the contents which should be distributed to the authenticated recording and/or recording apparatus, and a second database comprising a list of registered ID information; the information distribution apparatus decides whether information distribution is permitted or refused to the recording and/or reading apparatus based on the ID information read out from the recording medium installed on the recording and/or reading apparatus and the ID information in the second database, and transmits the contents stored in the first database to the recording and/or reading apparatus based on the decision. Such system includes a reading controller for controlling the recording and/or reading apparatus so that the recording and/or reading apparatus reads out the ID information from the read-only area of the recording medium installed in the recording and/or reading apparatus when an information distribution request is sent from the recording and/or reading apparatus to the information distribution apparatus; and recording controller for controlling the recording and/or reading apparatus so that the distributed contents are recorded properly in the recording and/or reading area of the recording medium from which the ID information is read, just in case the ID information corresponds to the one registered in the first database.

Moreover, according to another preferred embodiment of the present invention, there is provided an information distribution apparatus corresponding to the information distribution system, the information distribution apparatus including: a first database containing distribution information; a second database containing ID information of the recording medium; reading controller for controlling the recording and/or reading apparatus, wherein the ID information is read out from the read-only area of the recording medium installed in the recording and/or reading apparatus if an information distribution request is sent from the recording and/or reading apparatus; distribution controller for deciding whether permitting or refusing information distribution to the recording and/or reading apparatus based on the ID information read out from the recording/reading apparatus and ID information in the second database, and for reading distribution information from the first database based on the deciding; and recording controller for controlling the recording and/or reading apparatus, the distribution information read-out from the first database being recorded in a recording and/or reading area of the recording medium from which the ID information is read out.

As it can be understood from the above, according to the information distribution method of the present invention, authentication of the recording medium can be made based on the ID information recorded in the read-only area of the recording medium in a non-rewriting manner. As a result, judgment of information distribution is made based on reliable authentication of the recording medium and the distributed information can be recorded only in the authenticated recording media. Consequently, a new business model has been developed for selling recording media together with information to be distributed and collecting the charges for such information distribution in a prepaid manner without the need for a password and a credit card number. Furthermore, permission for downloading the distributed information is available only for the recording medium having specific ID information, thus protecting security of the information.

Furthermore, it is possible to implement the information distribution method of the present invention according to the information distribution system and the information distribution apparatus of the present invention.

### BRIEF DESCRIPTION OF THE DRAWINGS

The above and other objects, features and advantages of the present invention will become more apparent to those skilled in the art from the following description of the presently preferred exemplary embodiments of the invention taken in conjunction with the accompanying drawings, in which:

FIG. 1 is a schematic example of a recording medium (magnetic recording medium) used in a first preferred embodiment of the present invention;

FIG. 2 is a schematic cross sectional view of the read-only area of the recording medium as shown in FIG. 1;

FIG. 3 is another schematic example of the recording medium (magnetic recording medium) used in the first preferred embodiment of the present invention;

FIGS. 4(A) to 4(D) are schematic cross sectional views illustrating steps of fabricating a recording medium, according to a preferred embodiment of the present invention;

FIG. 5 is a flowchart for describing a way of acquiring the ID information from the recording medium, according to a preferred embodiment of the present invention;

FIGS. 6(A) and 6(B) schematically illustrate a way of acquiring the ID information from the recording medium according to the first preferred embodiment of the present invention;

FIG. 7 is a graph for obtaining an optimum current flowing through a magnetic head for acquiring the ID information from the recording medium according to the first preferred embodiment of the present invention;

FIGS. 8(A) and 8(B) show ID information signal read out from the read-only area of the recording medium according to the first preferred embodiment of the present invention;

FIGS. 9(A) and 9(B) show another example of method of acquiring the ID information from the recording medium according to the first preferred embodiment of the present invention;

FIG. 10 is a flowchart of a first example of the information distribution method according to according to a preferred embodiment of the present invention;

FIG. 11 is a flowchart of a second example of the information distribution method according to another preferred embodiment of the present invention;

FIG. 12 is a schematic block diagram illustrating the construction of the information distribution system and the information distribution apparatus according to a preferred embodiment of the present invention;

FIG. 13 shows a schematic construction of the recording/reading apparatus on which the recording medium of the first preferred embodiment of the present invention is installed;

FIG. 14 is a schematic perspective view of a recording medium (optical recording medium) to be used in the second preferred embodiment of the present invention;

FIG. 15 is a partial cross sectional view of the recording medium as illustrated in FIG. 14, according to a preferred embodiment of the present invention;

FIG. 16 is a schematic cross sectional view of an example of the recording/reading area (rewritable type) of the recording medium to be used in the second preferred embodiment of the present invention;

FIG. 17 is a schematic cross sectional view of another example of the recording/reading area (rewritable type) of the recording medium to be used in the second preferred embodiment of the present invention;

FIG. 18 is a schematic cross sectional view of another example of the recording/reading area (write once type) of the recording medium to be used in the second preferred embodiment of the present invention;

FIG. 19 is a schematic cross sectional view of a still another example of the recording/reading area (write once type) to be used in the second preferred embodiment of present invention;

FIGS. 20(A) and 20(B) show the ID information signal read out of the read-only area of the recording medium according to the second preferred embodiment of the present invention;

FIG. 21 is a schematic perspective view of an example of the recording medium (optical recording medium) to be used in a third preferred embodiment of the present invention; and

FIG. 22 is a schematic cross sectional view of a main portion of the recording medium as illustrated in FIG. 21, according to a preferred embodiment of the present invention.

### DESCRIPTION OF THE PREFERRED EMBODIMENTS OF THE PRESENT INVENTION

Preferred embodiments of an information distribution method, an information distribution system and an information distribution apparatus according to preferred embodiments of present invention will be described in greater detail by reference to the accompanying drawings. Among various embodiments, descriptions will be made first on the construction of a recording medium to be employed in a first embodiment of the present invention. Subsequently, an information distribution method to be performed by preferably using the recording medium will be described. Then, the construction of an information distribution system and an information distribution apparatus for implementing the information distribution method will be described. In order to avoid redundancy, in further second and third embodiments, description of constructions or portions that are similar to the first embodiment will be omitted.

(First Embodiment)

In a first preferred embodiment of the present invention, a description will be made of an example employing a disc-type recording medium containing identification information (hereinafter referred to simply as “ID information”) in a form of bump-groove pattern recorded in the read-only area as a recording medium.

Recording Medium

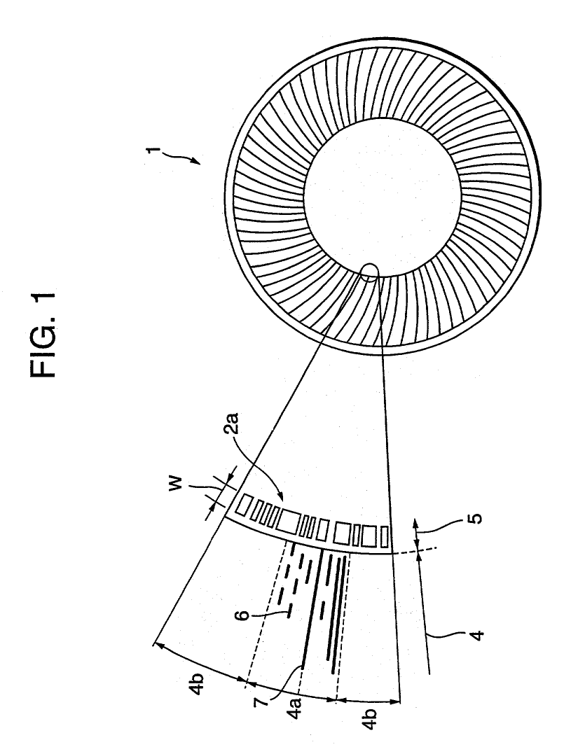

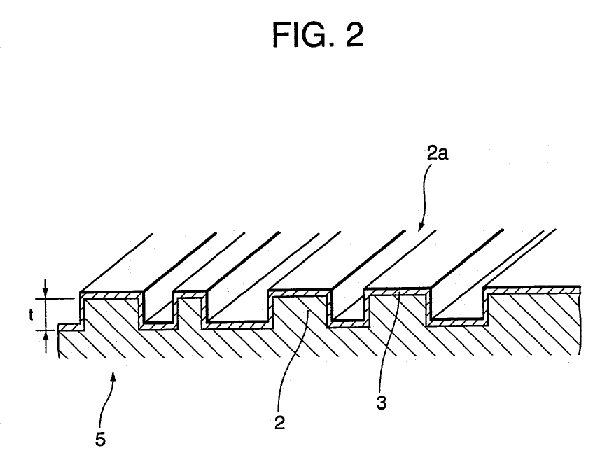

A recording medium to be employed in the first preferred embodiment is of the disc-type recording medium having both recording/reading (i.e., recording and/or reading) area and read-only area. In particular, the information recorded in the read-only area is a bump-groove pattern. Illustrated in FIG. 1 are a plan view and corresponding partial magnification of an example of such recording medium. FIG. 2 is a cross sectional view corresponding to the magnified portion in FIG. 1.

The recording medium as illustrated in FIGS. 1 and 2 is a magnetic recording medium 1 comprising a disc-shaped supporting substrate 2 made from a non-magnetic material having a magnetic recording layer 3 on at least one surface of the supporting substrate 2 (refer to FIG. 2). The magnetic recording medium 1 includes a recording/reading area 4 in which information can be rewritten, and a read-only area 5 in which information specific to the magnetic recording medium is prerecorded.

The recording/reading area 4 is an area having the same construction as a normal magnetic recording medium and comprises the magnetic recording layer 3 on the flat surface of the supporting substrate 2. Provided in the recording/reading field are a servo area 4a having a servo mark 6 and a track number 7 recorded therein and a data area 4b for recording information.

On the other hand, the read-only area 5 is provided in one part of tracks and comprises ID information in the form of bump-groove pattern 2a on the surface of the supporting substrate 2 and covered with a magnetic recording layer 3.

Preferably, the read-only area 5 is formed an inner most track of the readable area of the magnetic recording medium 1. It is to be noted that FIG. 2 is a cross sectional view of the read-only area in a circumferential direction.

The bump-groove pattern 2a is in the form of bumps and grooves having depth “t” of, e.g., about 45 nm provided in a predetermined length along the circumferential direction and a in predetermined spacing on the magnetic recording medium 1 to constitute ID information. A width W of the bump-groove pattern 2a, i.e., a width of the magnetic recording medium 1 in the radial direction is provided so as to absorb a deviation of the center of the bump-groove pattern 2a from the center of rotation of the spindle motor when the magnetic recording medium 1 rotates in the recording/reading apparatus.

Taking accuracy of assembly of a cassette containing the magnetic recording medium 1 and the recording/reading apparatus into consideration and assuming that tolerance of matching the spindle shaft in the recording/reading apparatus to the inner diameter of the magnetic recording medium is, e.g., about 20 μm, it is preferable that the recording width W of the bump-groove pattern 2a is set to 20 μm or larger. Such setting of the recording width W of the bump-groove pattern 2a equal to or larger than the matching tolerance ensures that a magnetic head mounted in a predetermined radial position remains in the track of the bump-groove pattern 2a despite eccentricity of the magnetic head. As a result, the ID information of the bump-groove pattern 2a can be read satisfactorily without need of using a tracking servo motor.

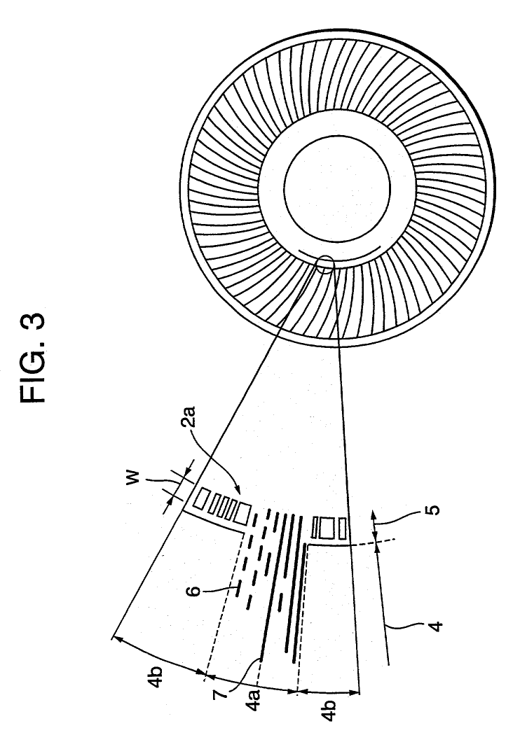

As illustrated in FIG. 3, it is preferable that the read-only area 5 may have the servo area 4a having the servo mark 6 and the track number 7 recorded therein similar to the recording/reading area 4, thereby performing tracking control of the magnetic head for the bump-groove pattern 2a. In this particular construction, the recording width W of the bump-groove pattern 2a may have substantially the same recording width as the recording width in the recording/reading area 4, thereby minimizing the space occupied by the bump-groove pattern 2a and increasing the recording/reading area. It is to be noted that the read-only area is not limited to the inner most location of the magnetic recording medium 1.

In the read-only area 5, it is possible to record ID information that is not supposed to be forged, e.g., a distributor code, total available prepaid credits for the information to be distributed, and distributed information category code for, e.g., the purpose of information distribution to the magnetic recording medium 1 via the Internet.

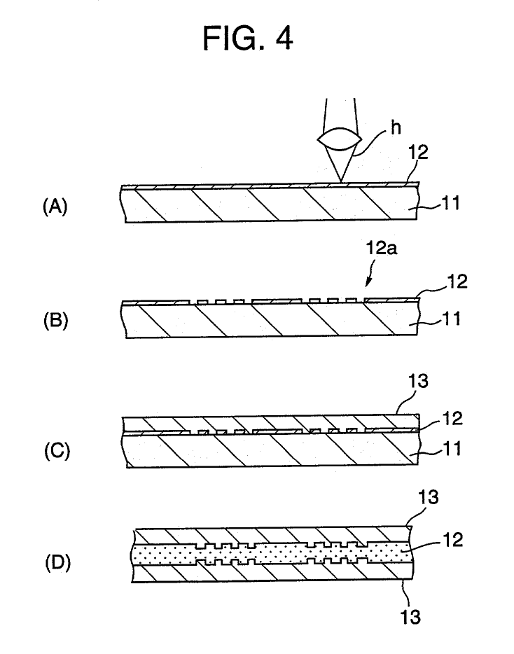

In addition, a fabrication method of an example of the abovementioned magnetic recording medium will be described by reference to FIGS. 4(A) and 4(B).

First, as illustrated in FIG. 4(A), a positive photo resist layer 12 is uniformly applied onto a smoothly polished surface of a glass substrate 11, preferably having a uniform thickness (of, e.g., 50 nm). Subsequently, a focused laser beam h having a small spot size (e.g., 400 nm in diameter) through an object lens is exposed in a pattern on the circumference of the read-only area of the magnetic recording medium. Then, as illustrated in FIG. 4(B), the photo resist layer is developed to remove the exposed portion of the photo resist, thereby leaving on the glass substrate 11 groove portions of the bump-groove pattern 12a formed by removing the photo resist 12. A next step is illustrated in FIG. 4(C) in which a nickel plated layer of, e.g., 0.4 mm in thickness is applied by way of a vapor deposition film in such a manner so as to cover the resist pattern 12a on the glass substrate 11, thereby forming a stamper 13. The stamper 13 is formed with the bump-groove pattern along the circumferential position corresponding to the read-only area.

It is to be noted that the formation of the stamper 13 is not limited to the plating. The bump-groove pattern may be formed by etching a polished metal plate to obtain the stamper 13.

Subsequently formed is the supporting substrate having the transcribed bump-groove pattern of the stamper 13 by injection mold. For this end, a pair of front and rear stampers 13 functioning as a die for a disc are attached to an injection mold machine (not shown). At the start of the molding process, the injection mold machine moves the pair of stampers 13 towards to each other to the distance equal to the thickness of the disc substrate while the surfaces of the stampers 13 are facing each other, thereby forming a closed cavity corresponding to the shape of a disc substrate by the pair of stampers 13 and surrounding die parts. Molten resin is injected into the cavity under high pressure through a nozzle disposed at the portion corresponding to the center of the disc substrate, thereby faithfully transcribing the bump-groove pattern on the surface of the stamper. After cooling, the resin in the cavity is picked off to obtain the supporting substrate 2 made from resin having the preferably faithfully transcribed bump-groove pattern. The supporting substrate 2 formed by injection of the resin to the pair of stampers 13 facing each other is schematically shown in FIG. 4(D).

After forming the supporting substrate 2 having the bump-groove pattern as described above, the magnetic recording layer 3 as illustrated in FIG. 2 is applied onto the surface of the supporting substrate 2 by sputtering. The magnetic recording layer 3 is made from a magnetic material such as, e.g., CoCrPt and is made using, e.g., a sputtering machine. The sputtering machine comprises a target of a magnetic material disposed in a vacuum chamber together with the disc substrate. The target is bombarded by ions of inert gas, e.g., argon to eject atoms of the target material to adhere onto the supporting substrate 2, thereby forming the magnetic recording layer 3 on the supporting substrate 2. Subsequently, it is possible to apply a protection film having hardwearing and lubricating properties such as carbon or the like by sputtering. The magnetic recording medium 1 is completed by applying a lubricating agent on the outermost surface, if necessary, after sputtering.

It is to be noted that the fabrication of the supporting substrate 2 having the bump-groove pattern is not limited to the injection molding using the stamper 13. The bump-groove pattern may be directly formed by etching the flat surface of the supporting substrate. In this case, a resist pattern is formed on the disc-shaped supporting substrate by lithographic processing. The resist pattern is used as a mask for etching the surface layer of the supporting substrate by ion trimming or other process.

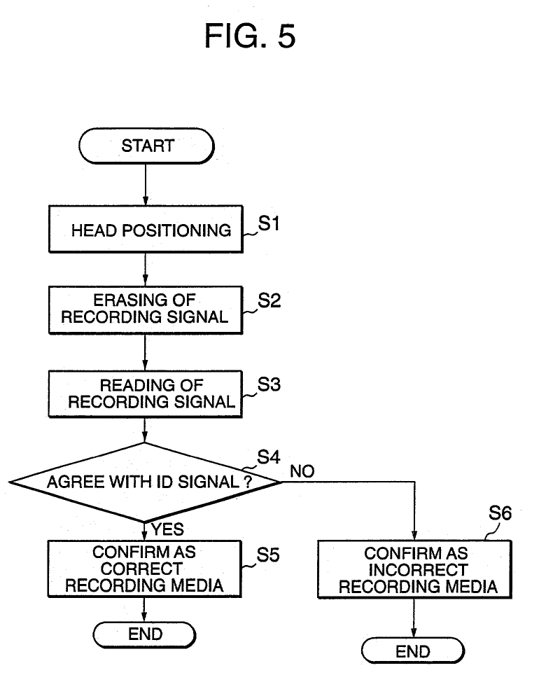

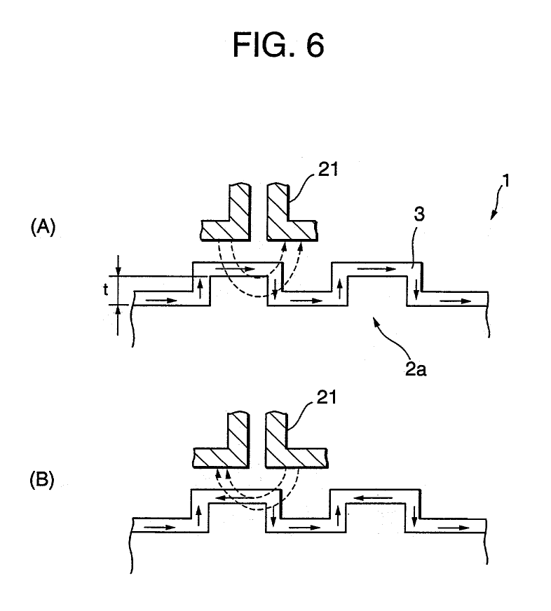

Furthermore, the way of acquiring ID information of the magnetic recording medium having the above construction will be described by reference to the flowchart in FIG. 5 and the cross sectional views of FIGS. 6(A) and 6(B). The ID information to be acquired is information as recorded on the bump-groove pattern in the read-only area of the magnetic recording medium.

First, the recording/reading head (magnetic head) is positioned onto the read-only area 5 of the magnetic recording medium 1, in step S1. Then, signal erasing is carried out on the magnetic recording layer in the read-only area of the magnetic recording medium 1, in step S2.

In this step, a first erasing is carried out on the magnetic recording layer 3 covering the bump-groove pattern 2a formed in the read-only area 5 of the magnetic recording medium 1 as illustrated in FIG. 6(A). Such erasing is carried out while making relative movement of the magnetic head 21 on and along the bump-groove pattern 2a, i.e., in the circumferential direction of the magnetic recording medium 1 (or left to right in the drawing). It is to be noted that DC erasing is carried out in the first erasing by applying sufficient DC current through the magnetic head 21 so that any information in the magnetic recording medium 1 at bumps and grooves of the bump-groove pattern 2a, thereby magnetizing the magnetic recording layer 3 at both bumps and grooves of the bump-groove pattern 2a in a same direction. For example, in the case where the depth t of the bump-groove pattern 2a is about 45 nm, erasing is carried out while applying about 50 mA current through the magnetic head 21 in the first erasing.

Subsequently, a second erasing is carried out onto the same magnetic recording layer 3 as the first erasing as illustrated in FIG. 6(B). In the second erasing, DC erasing is carried out while applying a relatively small DC current through the magnetic head 21 so as to erase the information only in the bumps of the bump-groove pattern 2a. In this case, the current in the magnetic head 21 is in an opposite direction to the current in the first erasing and the current is set to, e.g., about −11 mA. As a result, the magnetic recording layers 3 at the bumps and grooves of the bump-groove pattern 2a are magnetized in the opposite directions to each other.

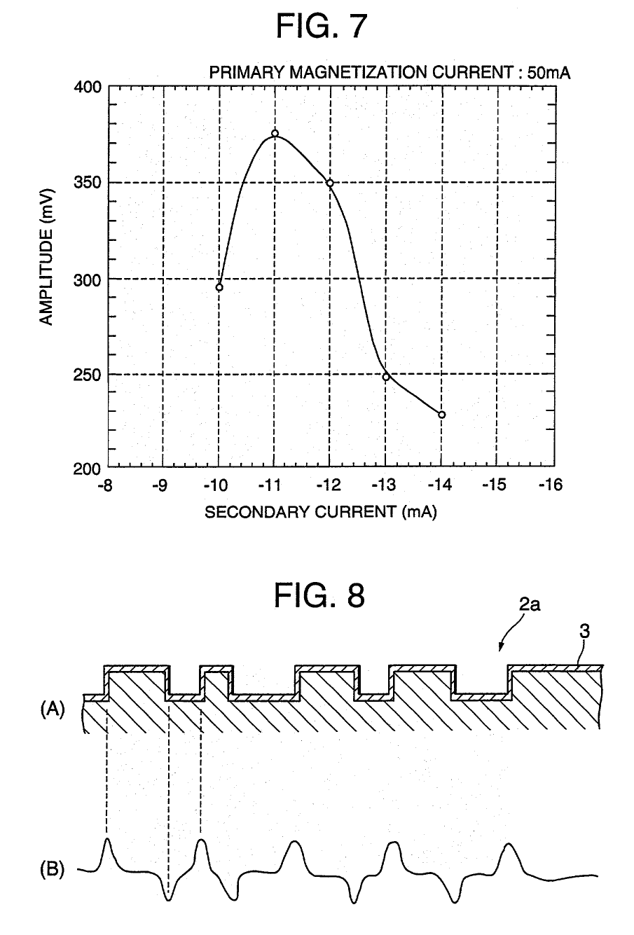

Preferably, current value in the second erasing is chosen so as to obtain a maximum output from the magnetic recording layer 3 on the bump-groove pattern 2a after completing the second erasing. FIG. 7 shows a graph of output (amplitude) change as a parameter of the current for the second erasing (secondary current) when the first erasing is carried out with 50 mA. As apparent from the graph, the maximum output is obtained at the secondary current of −11 mA when the first erasing is carried out with 50 mA. The graph suggests that the current value for the second erasing should be set to −11 mA.

After carrying out the first and second erasing operations as mentioned above, the magnetic signal on the magnetic recording layer 3 on the bump-groove pattern 2a is read as the ID information, in step S3.

According to the ID information acquisition in the above manner, if the bump-groove pattern 2a is, e.g., as illustrated in FIG. 8(A), the read-out ID information depends on the bump-groove pattern 2a as illustrated in FIG. 8(B) and has peaks at the boundaries of the bumps and their sidewalls.

Then, judgment is made based on the read-out signal whether or not the recorded signal in the read-only area 5 match the proper ID information, in step S4. If it is determined that the proper ID information is recorded (Yes), the recording medium is determined to be the correct or properly authenticated recording medium, in step S5. On the other hand, if it is determined in step S4 that the proper ID information is not recorded (No), the recording medium 1 is determined to be an incorrect or not the properly authenticated recording medium, in step S6.

It is to be noted that, if any false ID information be recorded in the recording/reading area 4 of the recording medium 1, e.g., as illustrated in FIG. 1, no signal information can be read out from the magnetic recording layer in the recording/reading area 4 even if any attempt is made to read the recording/reading area 4. Also, in an event where read-out operation of the ID information is performed by a magnetic head on a counterfeit disc having the recording/reading area over the entire area and having counterfeit ID information recorded at the same radius location as the read-only area 5 in FIG. 1, no signal information can be read. As a result, according to the series of steps as mentioned above, ID information depending on only the magnetic recording layer on the bump-groove pattern 2a can be read as the ID information. In other words, modifying, erasing or counterfeiting of ID information is impossible, thereby ensuring reliable authentication of the magnetic recording medium based on the read-out ID information.

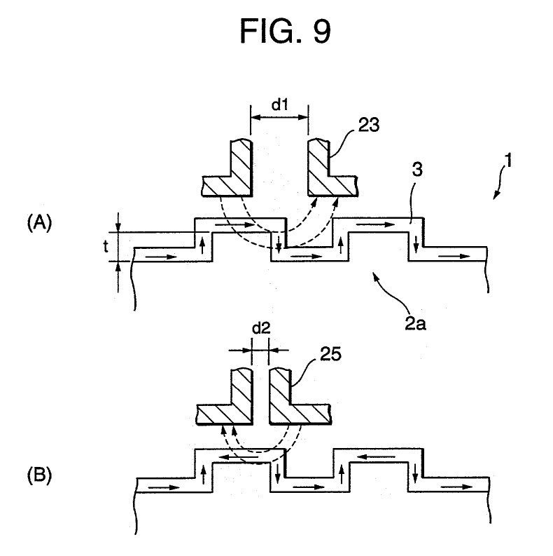

It is to be noted that the first and second erasing operations in the above mentioned ID information acquisition may be made in the following manner. That is, a first erasing operation is carried out in a same manner as mentioned above using a magnetic head 23 having a first gap d1 as illustrated in FIG. 9(A). Then, a second erasing operation is carried out using a magnetic head 25 having a narrower gap d2 than the first gap d1 as illustrated in FIG. 9(B) with the same current value as the first erasing but opposite direction. Similar to the above, the second gap d2 of the magnetic head 25 is chosen to obtain maximum output from the magnetic recording layer 3 on the bump-groove pattern 2a after carrying out the second erasing operation.

In such first and second erasing operations, it is possible to vary the zone to which the magnetic field affects by controlling the gap of the magnetic head. As a result, the same erasing as mentioned above can be carried out and information can be read depending on the bump-groove pattern 2a.

In case of acquiring ID information, the magnetic head for recording, erasing and reading the magnetic recording medium 1 is aligned with the read-only area of the magnetic recording medium 1. In case of not using the servo field 4a in the read-only area 5 of the magnetic recording medium 1 as illustrated in FIG. 1, positioning of the magnetic head is made at the inner most circumference of the magnetic recording medium 1 without tracking control.

In the condition when the magnetic head is positioned to the read-only area 5, there is no possibility of off-tracking the magnetic head from the bump-groove pattern 2a because it has a sufficient width. However, the width of magnetization by the magnetic head is considerably narrower than the recording width of the bump-groove pattern 2a. Accordingly, in a case where the magnetic head is provided with only one record erasing portion (gap portion), the first erasing operation must be carried out over a relatively wide portion (width in the radial direction of the magnetic recording medium) on the bump-groove pattern 2a so as to ensure the second erasing operation to be carried out on the magnetized portion by the first erasing operation.

In this case, the first erasing operation is carried out while shifting the magnetic head in the recorded zone or width of the bump-groove pattern 2a, thereby providing a relatively large magnetized width by the first erasing operation. Such width is chosen to absorb any deviation between the magnetic recording medium 1 and the magnetic head when the magnetic recording medium 1 revolves. After completing the first erasing operation, the second erasing operation is carried out over the magnetized portion by the first erasing operation. It is therefore possible to read the magnetic signal on the circumference where the second erasing operation is carried out using a reading portion (for example, a magneto resistive element—MR element) of the magnetic head integrally formed with the erasing portion.

On the other hand, in a case where a magnetic head having separate erasing portions for the first erasing operation and the second erasing operation is used, the magnetic head is constructed so as to carry out the second erasing operation and subsequent reading operation of magnetic signal immediately after the first erasing operation. This eliminates the need for increasing the magnetized width of the first erasing operation and the second erasing operation as mentioned above, thereby enabling to acquire the ID information by a single scanning of the magnetic head. Similarly, in a case where the servo area 4a is provided in the read-only area of the magnetic recording medium 1 (refer to FIG. 3), there is no need for increasing the magnetization width of the first erasing operation and the second erasing operation as mentioned above, because correct positioning of the magnetic head can be made by tracking control of reading the track number and the servo mark.

(Information Distribution Method-1)

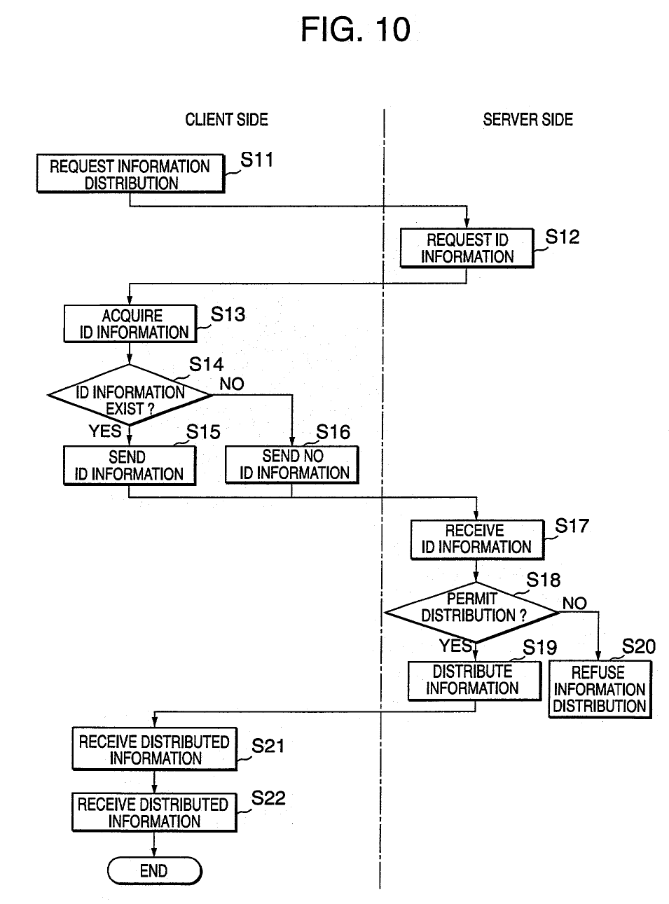

An example of information distribution method according to the present invention using the above mentioned magnetic recording medium is described by reference to a flowchart in FIG. 10. In this particular example, description will be made when information such as music and moving image is distributed to a magnetic recording medium installed in the recording/reading apparatus having the above construction from a server (information distribution apparatus) of a distribution provider by way of Internet. In FIG. 10, a group of programs at the client side are shown at the left hand side while a group of programs of the server side are shown at the right hand side.

It is assumed that the magnetic recording medium disposed in the recording/reading apparatus has ID information in the form of bump-groove pattern prerecorded in the read-only area by the distribution provider. The prerecorded ID information in the read-only area should not be forged and should not be required to be renewed after receiving distributed information. More specifically, it is preferable that prerecorded information includes the distribution provider code, total prepaid credits (e.g., information distribution valid for 10 hours), category code of the distribution information, etc.

A client or a person who has any information distributed goes to a store to purchase magnetic recording medium including the above mentioned prerecorded ID information at a price depending on the total prepaid credits of information. Such magnetic recording medium is installed in the recording/reading apparatus of a user terminal such as, e.g., a personal computer. The client follows the following procedures to have any information distributed:

Firstly, the client sends an information distribution request to the server, in step S11. It is assumed that the client wants to have, e.g., 2-hours of moving picture programs distributed. Then, the server sends instructions to the client's recording/reading apparatus for reading ID information recorded in the read-only area of the magnetic recording medium, in step S12. When the instructions are received, the client side acquires ID information in the form of bump-groove pattern recorded in the read-only area of the magnetic recording medium, in step S13. The ID information acquisition method as described hereinabove by reference to FIGS. 5, 6(A) and 6(B) is performed in this step.

In performing the ID information acquisition method as described hereinabove by reference to FIGS. 5., 6(A) and 6(B) at the client side, the recording/reading apparatus at the client side is provided with ID information detection control portion for executing the programs of the ID information acquisition method. If there is no program installed at the client side, it is possible to download a series of programs for performing the ID information acquisition method from the server side to the client side recording/reading apparatus (user terminal). It is also possible to perform the ID information acquisition method by controlling from the server side. It is to be noted that acquisition of ID information should not be limited to the above method as described by reference to FIGS. 5, 6(A) and 6(B) as long as the ID information in the form of bump-groove pattern formed in the read-only area of the magnetic recording medium can be read.

Subsequently, judgment is made whether or not ID information is recorded in the read-only area of the magnetic recording medium by the ID information acquisition operation, in step S14. The read-out ID information is sent to the server side, in step S15. On the other hand, if no ID information is recorded, “no ID information” is sent to the server, in step S16.

Upon receiving ID information from the client side, in step S17, the server analyzes the ID information to determine whether or not the information distribution is permitted to the medium, in step S18. In this case, information distribution is permitted if the ID information database managed at the server side agrees with the ID information transmitted from the client side and if the requested information amount does not exceed the recorded prepaid credits. Information is distributed to the client, in step S19. On the other hand, if no ID information exists in the database or if the requested information distribution amount exceeds the prepaid credits despite the fact that the ID information exists in the database, information distribution is refused (or, denied), in step S20.

At the client side, when distributed information from the server is received in step S21, the received information is recorded in the recording medium, in step S22. The distributed information (received information) is recorded in the recording/reading area of the recording medium from which the ID information is acquired in step S13.

According to such information distribution method, the recording medium is authenticated based on the non-rewritable ID information recorded in the read-only area of the recording medium. This ensures that information distribution is carried out only to the recording medium, which is reliably authenticated as the proper recording medium.

Particularly, when reading the ID information from the read-only area of the recording medium, in step S13, erasing of any recorded information for the recording/reading area is performed at the recording location for the ID information before the ID information acquisition as described hereinbefore by reference to FIGS. 5 6(A) and 6(B). As a result, only ID information depending on the bump-groove pattern is reliably read, thereby enabling to reliably authenticate the recording medium by the read-out ID information and to reliably perform information distribution to the proper recording medium only.

Consequently, the recording medium is sold together with information to be distributed thereto as mentioned hereinbefore, thereby establishing a new business model to collect charge for distributed information in a prepaid manner without the need of a password or credit card numbers. Additionally, permission to download the distributed information only to the proper recording medium having the particular ID information enables preserving a high degree of security of information.

(Information Distribution Method-2)

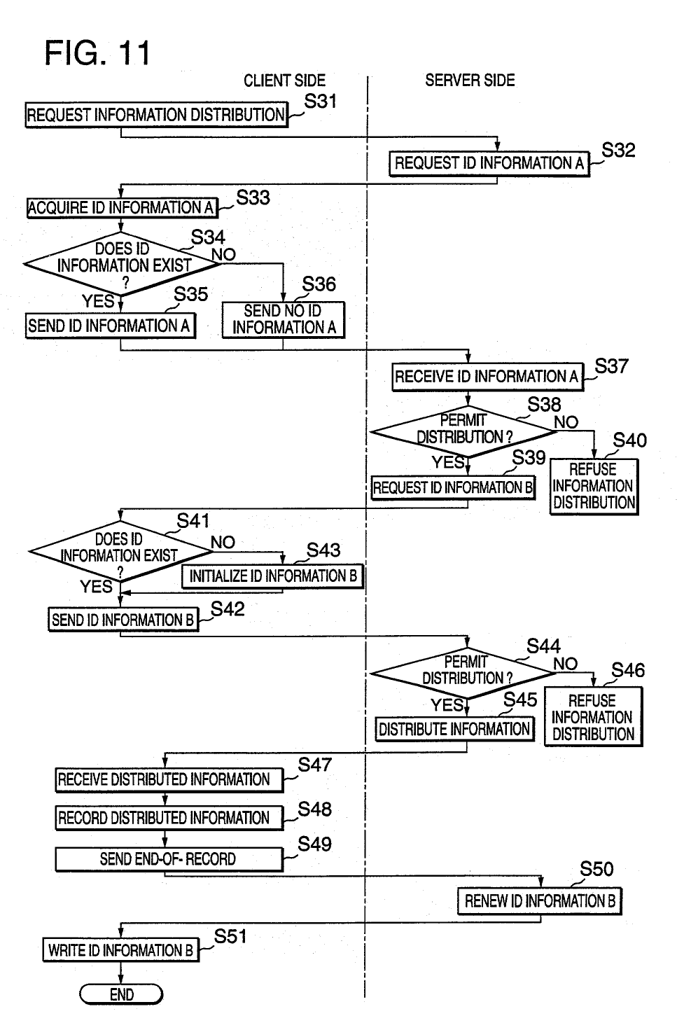

Another example of information distribution method using the magnetic recording medium as described hereinabove will be described by reference to the flowchart in FIG. 11. Similar to the above method, description will be made to distribute information such as music and moving pictures from the server (information distribution apparatus) of a distribution provider by way of the Internet to the magnetic recording medium having the above construction. In FIG. 11, a series of processing programs at the client side are shown at the left hand side while a series of processing programs at the server side are shown at the right hand side.

It is assumed that the ID information similar to the above mentioned distribution method-1 is recorded as ID information “A” in the read-only area of the magnetic recording medium installed in the recording/reading apparatus. Additionally, recorded in the recording/reading area of the magnetic recording medium at the shipment from a manufacturing plant is ID information “B” including ID number specific to the recording medium, the residual prepaid credits, etc. Since any information recorded in the recording/reading area can be altered, the information is preferably coded.

A person who wants to have any information distributed (client) purchases at a store such magnetic recording medium including the above mentioned ID information “A” and ID information “B” at the price including the information to be distributed corresponding to the total prepaid credits. Such magnetic recording medium is installed in the recording/reading apparatus such as, e.g., a personal computer. The client follows the following authentication and distribution procedures to have any information distributed.

Firstly, a information distribution request is sent from the client side to the server, in step S31, and the process to permit distribution is carried out based on the ID information “A” recorded in the read-only area, in step S38, in a similar manner to the above mentioned steps S11˜S18. However, in step S38, such judgment is made depending on whether or not the ID information “A” transmitted from the client side agrees with the database of ID information “A” managed at the server side.

Only if the recording medium is determined to be the specific one to which information distribution is permitted, instructions are sent to the client side for reading the ID information “B” in the recording/reading area of the recording medium, in step S39. On the other hand, if not agreed with the database in step S38, it is decided that the recording medium is not the proper one to permit information distribution, thereby refusing information distribution, in step S40.

Subsequently, when instructed by the server to send the ID information “B”, confirmation is made at the client side if ID information “B” is recorded in the recording/reading area, in step S41. Recorded as the ID information “B” are the ID number specific to the recording medium and prepaid credits as mentioned above in addition to the amount of distributed information received by the recording medium in the past. The client reads the ID information “B” out of the recording medium and returns such information to the server, in step S42. On the other hand, if no ID information “B” is recorded in the recording/reading area of the recording medium, it is assumed that the recording medium has never received distributed information and the ID information “B” is initialized, in step S43. Then, the initialized information may be transmitted to the server.

The server compares the ID information “B” transmitted from the client with the database. It is to be noted that the coded residual prepaid credits recorded at the shipment from a manufacturing plant and the code key used for coding it for each ID number of the recording medium are recorded in the database in the server to be used for deciding whether or not the distribution is permitted, in step S44. Judgment is made whether or not the ID number recorded as a part of the ID information “B” exists in the database and whether or not the requested amount of information distribution exceeds the residual prepaid credits recorded as a part of the ID information “B” after decoding by using the code key.

If a decision is made that the ID information “B” exists in the database and that the requested amount of information distribution does not exceed the residual prepaid credits, information distribution to the client is permitted, in step S45. On the other hand, if the requested amount of information distribution exceeds the residual prepaid credits in the ID information “B”, information distribution is refused, in step S46.

When the information distributed from the server is received, the client records the received information in the recording medium, in step S48. Upon recording the entire information, the client side returns the end-of-recording status to the server, in step S49.

The server calculates the residual prepaid credits by subtracting the presently distributed information from the residual prepaid credits in the ID information “B” and the renewed prepaid credits is coded using any code key before transmitting to the client, in step S60. Also, the ID number specific to the recording medium and the residual prepaid credits together with the code key are recorded in the database at the server side. On the other hand, the client overwrites the coded new residual prepaid credits as the ID information “B”, in step S51. The above steps complete the information distribution.

When second or subsequent information distributions are requested from the same client, the same steps as mentioned above are repeated. However, it is possible to use a different coding key from the one previously used for coding the ID information “B”.

If information distributions equal to the total prepaid credits have been received and the residual prepaid credits become zero, the recording medium may be brought to the store where the client has purchased it. The residual prepaid credits may be renewed by an exclusive writing apparatus upon payment of applicable charges for additional information. At this time, the exclusive writing apparatus renews it while communicating with the information distribution server. The server memorizes the ID number of the recording medium, renewed residual prepaid credits and a coding key used for coding thereof in an associated manner. Recorded in the ID information B in the recording medium are the ID number of the recording medium and the renewed and coded residual prepaid credits.

According to the information distribution method-2 as described above, the recording medium is authenticated based on the non-rewritable ID information recorded in the read-only area of the recording medium and the ID information is read after erasing the recording location for the ID information in the normal manner of erasing the recorded information in the recording/reading area, thereby achieving the same advantages as the information distribution method-1.

Additionally, according to the information distribution method-2, the ID information “A” recorded in the read-only area and the ID information “B” recorded in the recording/reading area are combined for more reliable authentication of the recording medium as well as individual authentication of each recording medium. As a result, it is possible to acquire information distribution history of each recording medium for performing various information distribution methods including a multi-step distribution for distributing information by dividing information into two or more recording media.

(Information Distribution System and Information Distribution Apparatus)

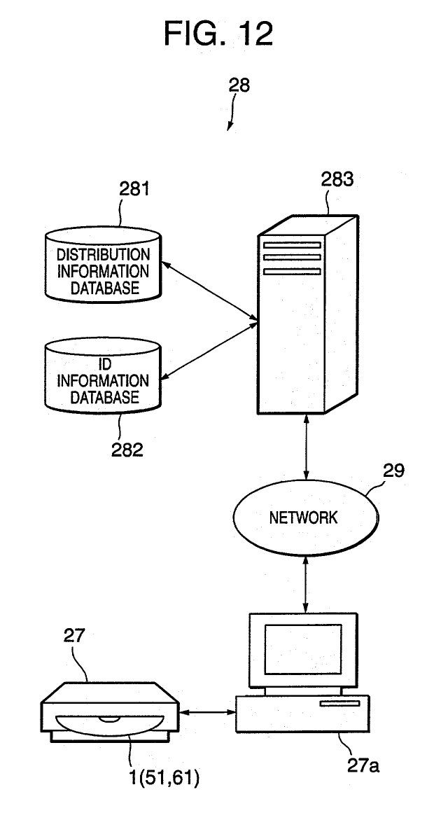

Illustrated in FIG. 12 is a schematic construction of an information distribution system and an information distribution apparatus for implementing the above described information distribution method using the magnetic recording medium 1 having the above-mentioned construction.

The information distribution system as illustrated in FIG. 12 comprises a recording/reading apparatus 27 for recording and reading information in the magnetic recording medium 1 having the above construction and an information distribution apparatus 28 connected to the recording/reading apparatus 27 for performing data communication therewith. The recording/reading apparatus 27 may be an HDD (hard disc drive) installed in a user terminal 27a such as a microcomputer. The recording/reading apparatus 27 can be connected to the information distribution apparatus 28 by way of a network 29.

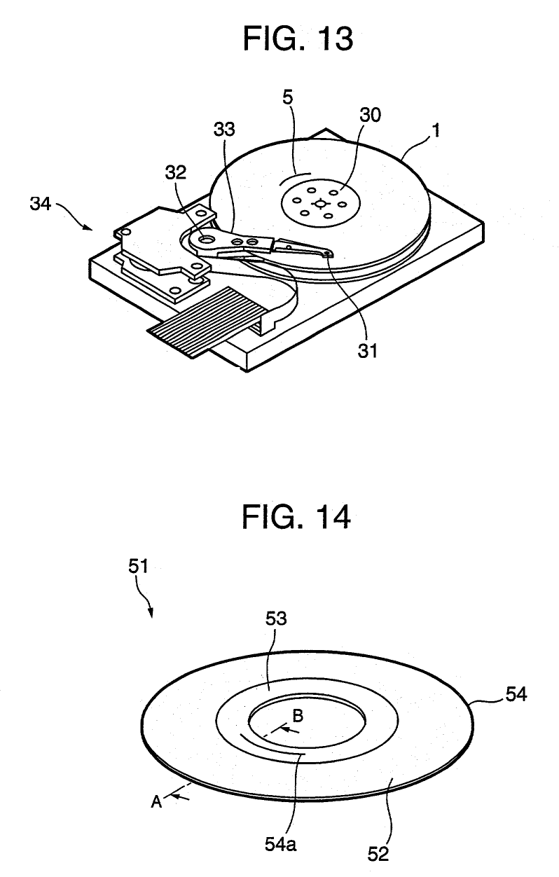

As illustrated in FIG. 13, the recording/reading apparatus 27 comprises the magnetic recording medium 1 mated with a spindle motor shaft 30 and a magnetic head 31 for recording, erasing and reading information in the magnetic recording medium 1. The magnetic head 31 is mounted on the end of a rotary arm 33 mounted onto a rotary bearing 32. The magnetic head 31 is positioned to a predetermined radius location of the magnetic recording medium 1 by a voice coil motor 34 which controls the rotation of the rotary bearing 32.

The magnetic head 31 is provided with, e.g., a magnetic gap for recording and erasing and an MR (magneto resistive) element exclusively for reading. Preferably, the magnetic gap for recording and reading may have a first gap and a second gap different from each other as described by reference to FIGS. 9(A) and 9(B). In this particular case, the magnetic head 31 is constructed in such a manner that the first wider gap, the second narrower gap and the MR element pass in this order on the track of the magnetic recording medium 1 revolving by the spindle motor.

The information distribution apparatus 28 as illustrated in FIG. 12 includes a distribution information database (first database) 281 and an ID information database (second database) 282 for recording the ID information of recording medium. A server main body 283 of the information distribution apparatus 28 acts as distribution controller for distributing information to the recording/reading apparatus 27, reading controller for acquiring ID information from the recording/reading apparatus 27 and recording controller for the distributed information.

The server main body 283 may have a function of a distribution controller in which a decision is made whether or not the information should be distributed to the recording/reading apparatus 27, based on the ID information read out of the recording/reading apparatus 27 and the ID information in the ID information database 282 and then reading the distribution information from the distribution information database 281 based of the above decision.

In addition, the server main body 283 may have a function of a reading (reproducing) controller in which the recording/reading apparatus 27 in the user terminal 27a is controlled so as to reading the ID information recorded in the read-only area of the magnetic recording medium 1 installed in the recording/reading apparatus 27 upon receiving an information distribution request from the recording/reading apparatus 27 by way of the (communication) network 29. When the reading controller reads the ID information from the read-only area of the recording medium 1, it is possible to control the recording/reading apparatus 27 so as to read the ID information after erasing the ID information in the recording/reading area corresponding to the recording position. In other words, the reading controller constitutes a section or unit for executing the programs for the ID information acquisition method as described by reference to FIGS. 5, 6(A) and 6(B).

The function as the recording controller of the server main body 283 records the distributed information read out of the distribution information database 281 in the recording/reading area of the recording medium from which the ID information was read.

It is to be noted that a group of programs for executing control procedures in the reading controller and the recording controller may be installed by downloading them from the information distribution apparatus into the user terminal 27a in the recording/reading apparatus 27, e.g., whenever an information distribution is requested by the recording/reading apparatus 27 to the information distribution apparatus 28 via the network 29.

According to the information distribution apparatus 28 having the above construction and the information distribution system provided therewith, it is possible to implement the information distribution method-1 as described hereinabove by reference to the flowchart in FIG. 10.

In order to implement the information distribution method-2 as described hereinabove by reference to the flowchart in FIG. 11, the information distribution apparatus 28 may be provided with the database relating to the above-mentioned ID information “B”. Also, the function as the distribution controller of the server main body 283 is a portion for making each judgment so that each processing in the flowchart is executed as a program.

Second Embodiment

A second embodiment of the present invention will be described in connection with an example of using a disc-shaped recording medium having a bump-groove pattern in a read-only area.

Recording Medium

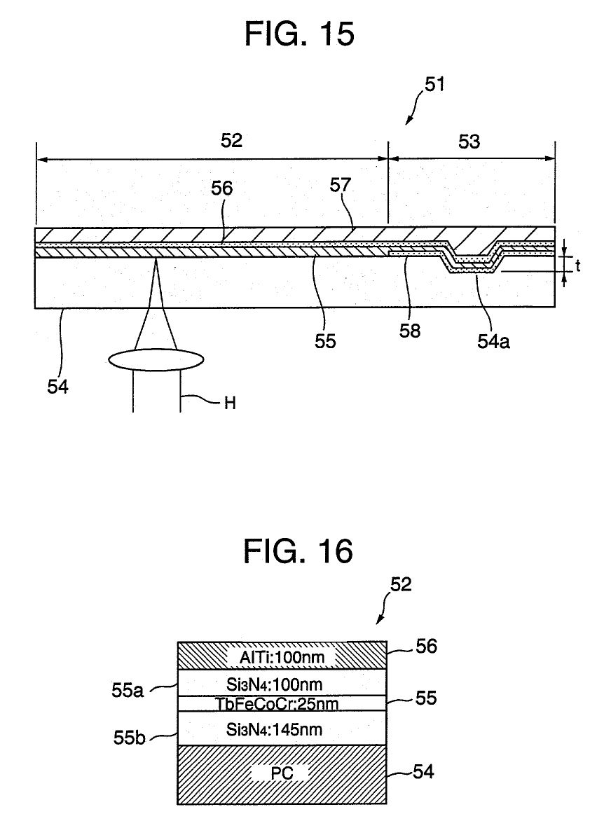

Illustrated in FIG. 14 is a perspective view of a recording medium and FIG. 15 is a cross sectional view along the line A-B in FIG. 14. The recording medium as illustrated in these figures is a disc-shaped optical recording medium 51 having on the disc surface an information rewritable recording/reading area 52 and a read-only area 53 for recording the disc information of the optical recording medium 51.

The recording/reading area 52 is an area on the main surface of the disc-shaped supporting substrate 55 made from a transparent material such as, e.g., polycarbonate (PC) having lamination of a thin film light reflection layer 56 by way of a thin film signal recording layer 55. Also provided is a protection layer 57 made from, e.g., photo setting resin in such a manner to cover the light reflection layer 56. Although not shown in the figures, the supporting substrate 54 is formed with channel-shaped grooves along recording tracks. The grooves act as recording/reading positions or addressing in the recording/reading area 52. Each layer is provided to cover the grooves.

It is to be noted that the recording/reading area 52 may be either of rewritable type or of write once type. If the recording/reading area 52 is of rewritable type, a magneto-optical material or a phase transition material may be used as the signal recording layer 55. On the other hand, if the recording/reading area 52 is of write once type, any material that occurs irreversible changes in crystal, bonding or shape upon light irradiation may be used as the signal recording layer 55.

The magneto-optical materials may include alloys of rare earth elements and transition elements such as TbFeCo, bFeCoCr, GdFeCo, GdFe, etc. The signal recording layer 55 may be a single layer, lamination of these material layers or sandwiched between Si layers. The signal recording layer 55 made from such magneto-optical material may be disposed between the supporting substrate 54 and the light reflection layer 56 with sandwiched between dielectric films.

Illustrated in FIG. 16 is a construction of an example of the recording/reading area 52 using the signal recording layer 55 made from such magneto-optical material. The signal recording layer 55 disposed on the supporting substrate 54 as illustrated in FIG. 16 is made from, e.g., TbFeCoCr and is provided between the supporting substrate 54 made from PC and the light reflection layer 56 made from AlTi while sandwiched between dielectric films 55a and 55b made from Si 3 N4. Each layer is a thin film and may have the exemplified thickness as shown in FIG. 16.

Other than the above, the signal recording layer 55 made from a phase transition material comprises a material capable of free phase transition between amorphous phase and crystalline phase by irradiating laser beam of different intensity or controlling heating/cooling speed by laser beam irradiation. In this case, since reflectance differs between the amorphous phase and the crystalline phase, signal is rewritable in the signal recording layer 55.

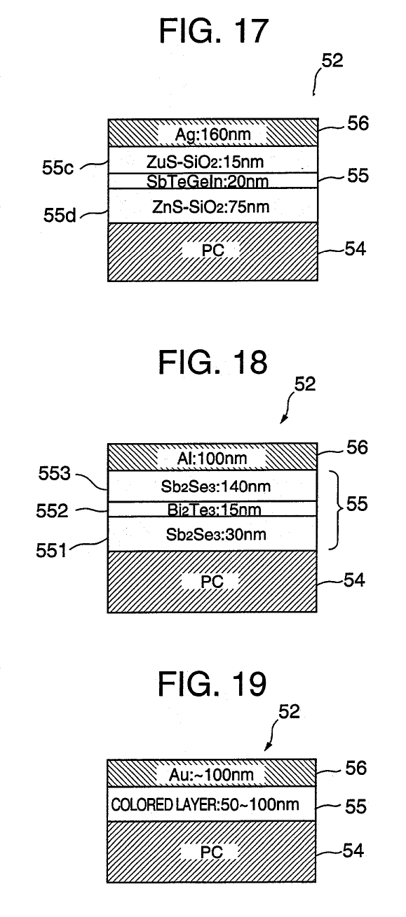

The signal recording layer 55 may be made from, e.g., chalcogens material such as Se, S, Te, etc., a film of Te—TeO2 alloy or SbTeGeIn film as illustrated in FIG. 17. Such signal recording layer 55 is provided between the supporting substrate 54 made from PC and the light reflection layer 56 made from Ag with sandwiched between, e.g., ZnS—SiO2 films 55c and 55d. Each layer is a thin film and may have the exemplified thickness as illustrated in FIG. 17. It is to be noted that the signal recording layer 55 having the shown construction can record the signal in a reversible manner due to phase transition of SbTeGeIn by light irradiation.

On the other hand, as for the write once type signal recording layer 55, low melting point metal films having different optical properties may be used by laminating so as to provide any desired reflectance by setting initial interference conditions. In the signal recording layer 55 having such construction, melt diffusion develops to lose the boundary between laminated layers by irradiating a laser beam, thereby changing reflectance. Such reflectance change is utilized for recording. Since such diffusion is irreversible, recording can be made only once.

An example of the signal recording layer utilizing such melt diffusion between laminated layers comprises a sequential lamination of Sb2Se3 film 551, Bi2Te3 film 552 and Sb2Se3 film 553 as illustrated in FIG. 18. In this case, used as the light reflection layer 56 is, e.g., Al. Each of these layers is a thin film and has the exemplary thickness as illustrated in FIG. 18. In the signal recording layer 55 having the above construction, Sb2Se3-Bi2Te3 alloy develops by irradiating light, thereby recording signal by varying light transmittance at light irradiated portions. The signal recording layer 55 is defined by Sb2Se3 film 551, Bi2Te3 film 552 and Sb3Se3 film 553.

On the other hand, another example of the write once signal recording layer 55 is a colored layer containing an organic dye material which changes color irreversibly upon light irradiation. Pigments suitable for such signal recording layer (i.e., colored layer) 55 include methine family pigment, benzene-thiol nickel complex, metal phthalocyanine pigment, naphtho-quinone pigment, etc. Also, one or more pigment selected from, e.g., cyanine family pigment (such as benzindoline family cyanine pigment) and phthalocyanine family pigment is used in combination with quencher for protecting deterioration of such pigment. In this case, Al is used as, e.g., the light reflection layer 56. Such signal recording layer 55 and the light reflection layer 56 are thin films having the exemplary thickness in FIG. 19. In the signal recording layer 55 having the above construction, molecular bonding condition of the recording film changes by light irradiation, thereby changing light transmittance at the light irradiated portions for recording information.

In addition to the above described signal recording layer 55, other techniques for melting the thin films to bore holes or inflating the thin film like bubbles by light irradiation can be applied to the signal recording layer 55.

On the other hand, the read-only area 53 is provided, e.g., in the tracks at the inner most circumferential portion of the supporting substrate 54. The read-only area 53 is formed with a row of pits 54a comprising a bump-groove pattern formed on the disc surface of the supporting substrate 54 in a continuous manner along the track in accordance with the recorded signal of the ID information. The signal recording layer 55 and the light reflection layer 56 are provided in such a manner to cover the row of pits. Additionally, a protection layer 57 is provided on the light reflection layer 58 by way of the signal recording layer 55 and the light reflection layer 56.

The row of pits 54a defines the ID information by disposing the bump-groove pattern having depth “t” of, e.g., about 45 nm and having predetermined length and spacing along a track of the optical recording medium 51. The recording width W (i.e., the width in the radial direction of the optical recording medium 51) of the row of pits 54a is chosen to be sufficient to absorb any deviation of the center of the circle made by the row of pits 54a with respect to the center of the spindle motor when the optical recording medium 51 revolves by the spindle motor in the disc apparatus.

In this case, assuming that the tolerance of matching between the spindle shaft of the disc apparatus and the inner diameter of the optical recording medium is about 20 μm judging from the accuracy of the cassette containing the optical recording medium 1 and the assembly of the disc apparatus, the recording width W of the row of pits 54a is preferably set to 20 μm or larger. By setting the recording width W of the row of pits 54a to substantially equal to or larger than the matching tolerance, the optical head mounted at a predetermined radial location is prevented form off tracking out of the row of pits 54a due to eccentricity of the optical head. This enables to effectively reading the ID information of the row of pits 54a without the need of a tracking servo.

The optical recording medium 51 having the above described construction enables to record and read information in and from the signal recording layer 55 by irradiating a laser beam H from the supporting substrate 54's side. In the case where the recording/reading area 52 is provided with the rewritable type signal recording layer 55, information can be recorded, read or erased by irradiating the laser beam H. However, in the case where the signal recording layer 55 includes a film made from a magneto-optical material, recording and erasing are carried out by irradiating the laser beam H from the supporting substrate 54's side as well as applying magnetic field from the protection layer 57's side.

It is to be noted that the light reflection layer 58 is unnecessary if signal of the row of pits 54a in the read-only area 53 can be read without causing any influence upon the signal recording layer 55 by irradiation of the laser beam H or if the signal recording area 55 is provided only in the recording/reading area 52. In contrary to the illustrated construction, it is possible to construct so that recording and reading as well as erasing are carried out by irradiating the laser beam H from the protection layer 57 side if it is made from a transparent material.

As far as fabrication of the optical recording medium having the above construction is concerned, a first step is to prepare the supporting substrate 54 made from a transparent material in a similar manner as the first embodiment which has been described hereinbefore by reference to FIGS. 4(A) to 4(D). A next step is forming films of, successively, the light reflection layer 58, the signal recording layer 55 and the light reflection layer 56 over the surface of the row of pits 54a on the supporting substrate 54 by a thin film forming technique such as sputtering. It is to be noted that the film forming of the light reflection layer 58 is carried out by film forming over a mask covering the recording/reading area 52, thereby forming the light reflection layer 58 exclusively at the read-only area. Subsequently, the protection layer 57 is applied over the light reflection layer 56, e.g., by spin coating a protection layer material and then curing such coating so as to obtain the protection layer 57,thereby completing the optical recording medium 51.

Read-out of the ID information from such optical recording medium 51 is carried out, e.g., in a similar manner as described hereinabove by reference to the flowchart in FIG. 5. However, in order to erase the recorded signal in the read-only area 53 according to step S2, a laser beam of substantially same intensity as the one for erasing the information in the recording/reading area 52 is irradiated onto the read-only area 53. If the optical recording medium is the magneto-optical recording medium, a magnetic head is positioned in tracking with the optical head. While irradiating light from the optical head, magnetic field from the magnetic head for recording is applied for erasing the signal recording layer by magnetizing in one direction.

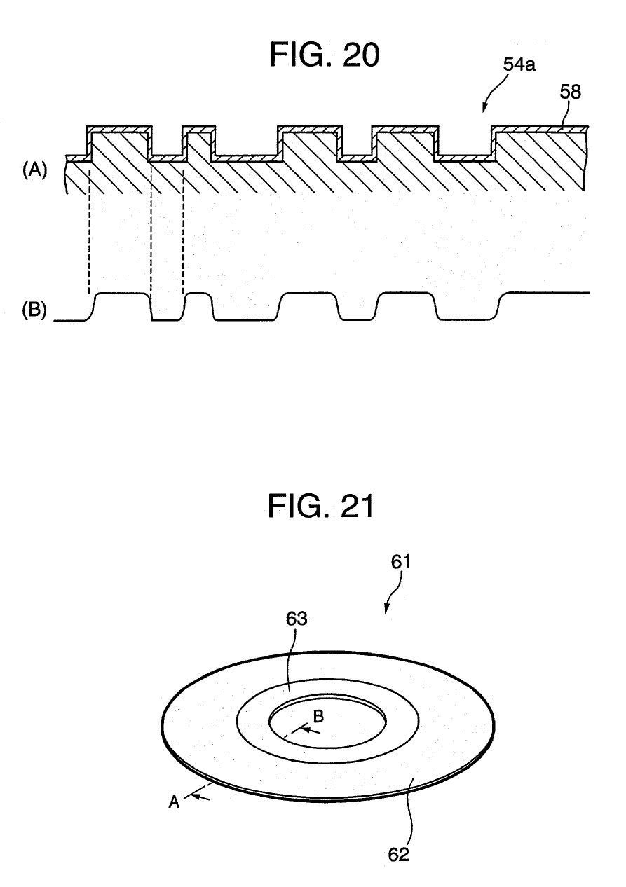

According to such ID information acquisition method, in case of the row of pits 54a, e.g., as shown in FIG. 20(A), the read-out signal is the ID information depending on the bump-groove pattern of the row of pits 54a as shown in FIG. 20 (B). In particular, if the recording/reading area 55 is of rewritable type, no signal can be read when the ID information reading is carried out at a location shifted from the read-only area 53. That is, only information recorded in the read-only area 53 can be read. This means that the recording medium 51 can be reliably authenticated based only on the ID information initially recorded in the read-only area of the recording medium 51.

(Information Distribution Method)

As the information distribution method using the above described optical recording medium 51, the information distribution method of the first embodiment of the present invention may be applicable as described hereinabove by reference to the flowchart of FIG. 10, and the information distribution method according to the present invention may be applicable as described hereinabove by reference to the flowchart of FIG. 11. Also, similar results as the resulting advantages of the first embodiment of the present invention may be obtained.

In particular, if the recording/reading area 52 of the optical recording medium 51 is of write once type, it is possible to eliminate the need for specially managing the amount of distribution information by simply setting the amount of the writable information in the recording/reading area 52 as the amount of information to be distributed. The ID information B as described hereinabove by using the flowchart of FIG. 11 is the non-rewritable information in the recording/reading area 52, thereby eliminating the need of encoding the ID information “B”.

(Information Distribution System and Information Distribution Apparatus)

The information distribution system and the information distribution apparatus of the first embodiment as described by reference to FIG. 12 is applicable to the information distribution system and the information distribution apparatus for implementing the above information distribution method using the optical recording medium 51 having the construction described above. However, the recording/reading apparatus 27 for this information distribution system is the recording/reading apparatus for an optical recording medium provided with an optical head or an optical head and a magnetic head.

Third Embodiment

A third embodiment of the present invention using a disc-shape recording medium provided with the read-only area for recording the ID information in the irreversible recording layer will be described below.

Recording Medium

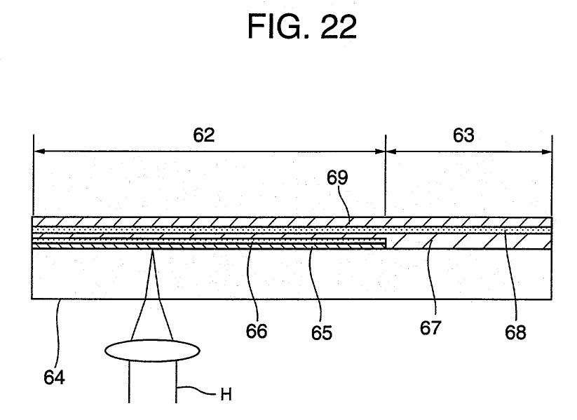

FIG. 21 is a perspective view of a recording medium, while FIG. 22 is a cross sectional view along the line A-B of FIG. 21. The recording medium as illustrated in these figures is a disc-shaped optical recording medium 61 having on its disc surface a recording/reading area 62 on which information is rewritable and a read-only area 63 on which the disc information of the optical recording medium 61 is recorded.

The recording/reading area 62 is for recording information in a rewritable manner or in a write once manner. The recording/reading area 62 includes a lamination of a thin film signal recording layer 65 and a thing film light reflection layer 66 disposed on one main surface of a disc-shaped supporting substrate 64 made from a transparent material such as, e.g., polycarbonate (PC).

On the other hand, the read-only area 63 is provided in part of tracks on a main surface of the supporting substrate 64, e.g., on several tracks at an inner most circumferential area. The read-only area 63 includes a lamination of a thin film write once type recording layer 67 and a thin film light reflection layer 68 disposed on the one main surface of the supporting substrate 64. The ID information is prerecorded in the write once recording layer 67, thereby disabling further recording on this area.

In the illustrated example, the signal recording layer 66 is a rewritable layer and both write once recording layer 67 and light reflection layer 68 are laminated on the light reflection layer 66 in the recording/reading area 62 for convenience of reducing fabrication steps. However, it is to be noted that the write once recording layer 67 and the light reflection layer 68 need not be laminated on the light reflection layer 66 of the recording/reading area 62 as long as the light reflection layer 66 is directly provided by way of only the signal recording layer 65 on the supporting substrate 64 in the recording/reading area 62 and the light reflection layer 68 is directly provided by way of only the write once recording layer 67 on the supporting substrate 64 in the read-only area 63.

If the signal recording layer 65 and the write once recording layer 67 are not laminated in the recording/reading area 62 and the read-only area 67, the light reflection layer 66 and the light reflection layer 68 may be a single common light reflection layer. Conversely, in consideration of reducing fabrication steps, it is possible that the rewritable recording layer 65 and the light reflection layer 66 are laminated on the light reflection layer 68 in the read-only area 63.

Furthermore, if the recording/reading area 62 is the write once type, it is possible that the signal recording layer 65 and the write once recording layer 67 are a single layer made from the same material.

Also provided on the supporting substrate 64 is a protection layer 69 made form, e.g., photo setting resin in such a manner as to cover the recording/reading area 62 and the read-only area 63 having the above construction.

Although not shown in the figures, channel-like grooves are formed in the recording/reading area 62 and the read-only area 63 along the recording tracks on the recording/reading side of the supporting substrate 64. Such grooves have recording/reading location, i.e., addressing function of the recording/reading area 62 and the read-only area 63. Each of the above described layers is formed in such a manner to cover such grooves.

If the recording/reading area 62 is of rewritable type, the signal recording area 65 is made from a material capable of recording, reading and erasing signals by irradiating laser beam H. The magneto-optical material or the phase transition material as described hereinabove by reference to the second embodiment can be used for such signal recording layer 65. On the other hand, the same signal recording layer as the write once type signal recording layer 55 as described hereinabove in the second embodiment may be used for the recording/reading layer 65 in the write once type recording/reading area 62 and the write once recording layer 67 in the read-only area 63.

The optical recording medium 61 having the above construction enables recording and reading the information in the signal recording layer 65 by irradiating the laser beam H from the supporting substrate 64 side. If the recording/reading area 62 is formed with the rewritable type signal recording layer 65, information can be recorded, read and erased by irradiating the laser beam H. However, if the signal recording layer 65 is made from a magneto-optical material, recording/reading operation is carried out by irradiating the laser beam H from the supporting substrate 64 side as well as applying magnetic field from the protection layer 67 side. In contrast to the illustrated construction, it is possible to carry out recording/reading as well as erasing by irradiating the laser beam H from the protection layer 57 side if it is made from transparent material.

As far as fabrication of the optical recording medium 61 having the above construction is concerned, a first step is to prepare the supporting substrate 65 made from a transparent material in a similar manner as the first embodiment as described hereinabove by reference to FIGS. 4(A) to 4(D). Then, the signal recording layer 65, the light reflection layer 66, the write once recording layer 67 and the light reflection layer 68 are sequentially made by a film forming technique such as sputtering. If the film is to be formed locally, a mask is used for film forming at necessary portions only. Then, the protection layer 67 is formed on the light reflection layer 66 to then finish the optical recording medium 61.

The optical recording medium 61 fabricated through the above steps is provided with the recording/reading area 62 as well as the read-only area 63 having the ID information of the optical recording medium 61 recorded therein. As a result, the optical recording medium 61 can be authenticated based on the ID information in the read-only area 62.

In particular, the read-only area 63 is the area in which the ID information is prerecorded in the write once recording layer for irreversible recording. The information recorded in the read-only area 63 is one recorded after manufacture of the optical recording medium 61, thereby enabling to record information specific to each optical recording medium 61. By recording the ID number specific to each optical recording medium 61 as the ID information in the read-only area 63, it is possible to authenticate each optical recording medium 61 provided with the recording/reading area 62 based on the ID information.

In particular, the recording/reading area 62 is a rewritable area and the read-only area 63 is entirely non-rewritable by irradiating the laser beam if once recording the ID information. As a result, only the ID information is recorded in the optical recording medium 61 as non-rewritable and non-erasable information.

Accordingly, by performing the ID information acquisition method in a similar manner as the second embodiment, it is possible to read as the ID information only the signal recorded in the read-only area 63.

(Information Distribution Method)

As for the information distribution method using the above described optical recording medium 61, the information distribution method as described hereinabove by reference to the flowcharts in FIGS. 10 and 11 for the first embodiment of the present invention is applicable, thereby providing similar advantages as of the first embodiment.

Particularly, since individual optical recording medium 61 can be authenticated, the ID number recorded as the ID information “B” particular to each recording medium in the first and second embodiments may function as the ID information “A”.

If the recording/reading area 62 is the write once type, it is possible to eliminate the need for specially managing the amount of information distribution by taking the entire amount of information that can be written in the recording/reading area 62 in a write once manner as the information amount to be distributed as described hereinabove in connection with the second embodiment of the present invention. Also, the ID information “B” as described hereinabove by reference to the flowchart in FIG. 11 is recorded in the recording/reading area 62 as the write once non-rewritable information, thereby eliminating the need for encoding the ID information “B”.

(Information Distribution System and Information Distribution Apparatus)

The information distribution system and the information distribution apparatus as described above in connection with the first embodiment by reference to FIG. 12 is also applicable to the information distribution system and the information distribution apparatus for implementing the above described information distribution method using the optical recording medium 61. However, the recording/reading apparatus for the optical recording medium is provided with the optical head or both of the optical head and the magnetic head.

In the above first through third preferred embodiments of the present invention, description is made in connection with the case of employing a disc-shaped recording medium. However, it is to be noted that the present invention should not be limited to the information distribution method, information distribution system and information distribution apparatus employing such disc-shaped recording medium but can be applied to, e.g., tape form recording medium. In this case, the ID information to be recorded in the read-only area may be, e.g., of a stripe shape of different reflection properties or transmittance so that the information can be read by an optical sensor provided in the recording apparatus side.

Also, as far as the information distribution methods as described hereinabove in the first through third preferred embodiments of the present invention are concerned, a new business model has been proposed in that the recording medium is sold together with the charges for the information to be distributed, thereby permitting realization of reliable charging for the distributed information in a prepaid manner without using a password and a credit card number. Other than the above described prepaid manner, the information distribution method of the present invention can be applied to a method for charging at any distribution of information in general.

In case of employing the recording media of the first and second preferred embodiments for example, such method can be realized in the following manner:

First, as described hereinabove by reference to FIG. 11, a recording medium to be installed on the disc apparatus is provided with the read-only area having the ID information prerecorded and the recording/reading area excluding the ID information “B” at the time of shipment from the manufacturing plant. Then, an individual (client) who wants to have any information distributed purchases such recording medium including the ID information “A” recorded therein at a store at a price excluding the charge for any information to be distributed. Then, the recording medium is installed in a disc apparatus of, e.g., a personal computer. When the client wants to have any information distributed, authentication and information distribution will be carried out in a manner as described below.

As already described above by reference to FIG. 11, an information distribution request is sent from the client side to the server, in step S31. Then, the client side and the server side follow the same steps as the above up to step S40. These steps permit downloading the distributed information based on the non-rewritable ID information “A” recorded in the read-only area of the recording medium and the information security is protected.

When the client side is requested by the server to transmit the ID information “B” such as the history information and the ID number, in step S39, confirmation is made whether or not the ID information is recorded in the recording medium. Since no ID information “B” is recorded in this case, the server side confirms that this is a first access from the client and requests any information to guarantee the payment for the charge such as the credit card number (chargeable information).

Upon receiving such information transmitted by the client in accordance with the request, the server side issues a proper ID number to the client side and records the charging information received from the client in association with the ID number.

On the other hand, the client side records the ID number issued by the server side in the recording/reading area of the recording medium. Subsequently, the server side transmits the distribution information to the client side and collects the charge. The client records the distributed information in the recording medium before completing the distribution.

For a second and subsequent information distribution requests from the client side, the server automatically acquires the ID number in the client's recording medium and collects the applicable charges from the client based on the charging information stored in association with the ID number.

It is to be noted in the above information distribution method that the number of digits of individual ID numbers is chosen to be sufficiently large so as to avoid unauthorized information distribution by someone else. For example, if a 128-digit binary number is used as the ID number, there are 3.4 multiplied by a 38^{th} power of 10 ID numbers. In this particular case, the probability of hitting any existing ID number by a single trial is extremely low, about one over 33^{rd} power of 10 even for a corporation having, e.g., 100,000 clients. It is to be noted, however, that failure to send a correct ID number is unlikely to occur, since the ID number is recorded in the recording medium. As a result, if a client tries to send wrong ID numbers for a number of times, such client is detected as a wrong access and information distribution is refused. The use of such method is effective so as to eliminate any need for transmitting the charging information such as the credit card number over the network at every information distribution, thereby assuring more reliable charging.

Also, collection of charges for information distribution using the recording medium in the above third preferred embodiment can be made as follows. That is, each recording medium includes an individual ID number prerecorded as the non-rewritable ID information “A”.

Then, as illustrated in FIG. 11, a request for information distribution is sent from the client side to the server, according to step S31. Subsequently, both of the client side and the server side follow the above steps up to step S40. As a result, downloading of the distribution information is permitted based on the individual ID information “A” recorded in a non-rewritable manner in the read-only area of the recording medium, thereby protecting security of the information.

When the client side is instructed by the server to transmit the history information, confirmation is made whether or not the history information is recorded in the recording medium. However, since no history information is recorded in this case, this is confirmed and the history information is initialized. At this time, the server side requests to the client the information to guarantee payment of the charge such as the credit card number.

If the client transmit the requested information in accordance with the instructions and the server received it, the server records the information to guarantee the payment for the charges transmitted form the client side in association with the non-rewritable individual ID information “A” (ID number) recorded in the read-only area of the recording medium. Subsequently, the server transmits the distribution information to the client and collects the charge for the distributed information. Then, the client may record the distributed information in the recording media to complete the information distribution (acquisition, from the client's point of view).

Charges for second and subsequent information distributions are collected using the charge collection information recorded in association with the ID information “A” (ID number) of each recording medium.

As described hereinabove, the use of the ID information “A” as prerecorded in the recording medium for authentication information for information distribution enable to permit downloading the distributed information only in the recording medium having the particular ID information “A”, thereby protecting security of the information.

Although the invention has been described in its preferred form with a certain degree of particularity, other changes, variations, combinations and sub-combinations are possible therein. It is therefore to be understood that any modifications will be practiced otherwise than as specifically described herein without departing from the scope and spirit of the present invention.

What is claimed is:

1. An information distribution method comprising the steps of:
reading ID information recorded in a read-only area of a recording medium having said read-only area and a recording and/or reading area;
deciding whether information distribution is permitted or refused based on said read-out ID information; and
recording distributed information as a result of said deciding step on said recording and/or reading area, signal.

2. The information distribution method according to claim 1, wherein said reading process of said ID information is performed after an erasing process performed at a recording position of said ID information corresponding to information recorded on said recording and/or reading area, when reading said ID information from said read-only area.

3. The information distribution method according to claim 2, wherein said recording and/or reading area comprises a rewritable area.

4. The information distribution method according to claim 1, further comprising the steps of:
reading ID information recorded in said recording and/or reading area together with ID information recorded in said read-only area; and
deciding whether information distribution is permitted or refused based on decision of said read-out ID information of the read-only area and said readout ID information of said recording and/or reading area.

5. The information distribution method according to claim 1, wherein said ID information is recorded as a bump-groove pattern on said read-only area.

6. The information distribution method according to claim 1, wherein said read-only area comprises said ID information, which is recorded on a signal recording layer in an irreversible manner.

7. An information distribution system having a recording and/or reading apparatus for recording and reading information in a recording medium, and an information distribution apparatus including a first database comprising contents to be distributed to the authenticated recording and/or recording apparatus, and a second database comprising a list of registered ID information, wherein said information distribution apparatus: decides whether information distribution is permitted or refused to said recording and/or reading apparatus based on said ID information read out from said recording medium installed on said recording and/or reading apparatus and said ID information in said second database, and transmits said contents stored in said first database to said recording and/or reading apparatus based on said decision, the system comprising:
reading controller for controlling said recording and/or reading apparatus so that said recording and/or reading apparatus reads out said ID information from said read-only area of said recording medium installed in said recording and/or reading apparatus when an information distribution request is sent from said recording and/or reading apparatus to said information distribution apparatus; and
recording controller for controlling said recording and/or reading apparatus so that said distributed contents are recorded in said recording and/or reading area of said recording medium from which said ID information is read, if said ID information corresponds to the one requested for said first database.

8. The information distribution system according to claim 7, wherein said reading controller controls said recording and/or reading apparatus when reading out ID information from said read-only area, wherein said reading out process of said ID information is performed after erasing recorded information corresponding to a recording position of said ID information.

9. An information distribution apparatus connected so as to communicate with a recording and/or reading apparatus on which a recording medium is installed, said information distribution apparatus comprising:
a first database containing distribution information;
a second database containing ID information of said recording medium;
reading controller for controlling said recording and/or reading apparatus, wherein said ID information is read out from said read-only area of said recording medium installed in said recording and/or reading apparatus if an information distribution request is sent from said recording and/or reading apparatus;
distribution controller for deciding whether permitting or refusing information distribution to said recording and/or reading apparatus based on said ID information read out from said recording/reading apparatus and ID information in said second database, and for reading distribution information from said first database based on said deciding; and
recording controller for controlling said recording and/or reading apparatus, wherein said distribution information read-out from said first database is recorded in a recording and/or reading area of said recording medium from which the ID information is read out.

10. The information distribution apparatus according to claim 9, wherein said reading controller controls said recording and/or reading apparatus when reading out ID information from said read-only area, wherein said reading process of said ID information is performed after an erasing process performed at a recording position of said ID information corresponding to information recorded on said recording and/or reading area.
